(19) United States
(12) Patent Application Publication
(10) Pub. No.: US 2002/0051225 A1
(43) Pub. Date: May 2, 2002

(54) Display apparatus, display method, and image processing system

(75) Inventor: Hiroyuki Karasawa, Fujisawa-shi (JP)

Correspondence Address: SUGHRUE, MION, ZINN, MACPEAK & SEAS, PLLC, 2100 Pennsylvania Avenue, N.W., Washington, DC, 20037-3213, US

(73) Assignee: FUJI PHOTO FILM CO., LTD.

(21) Appl. No.: 09/984,856

(22) Filed: Oct. 31, 2001

(30) Foreign Application Priority Data
Oct. 31, 2000 (JP) 2000-333000

(51) Int. Cl. H04N 1/00

(52) U.S. Cl. 358/437

(57) ABSTRACT

An error process unit for displaying an error message has a first process unit for detecting errors of various devices based on detected signals from sensors associated therewith, and a second process unit for outputting error messages depending on combinations of the detected errors. The second process unit has a retriever for retrieving a present error pattern based on a combination of the detected errors from an information table, and a message output process unit for reading an error message corresponding to the present error pattern and outputting the error message to a display if the present error pattern is present in the information table.

### BACKGROUND OF THE INVENTION

1. Field of the Invention

The present invention relates to an apparatus for and a method of displaying a detected error as an error message, and an image processing system for reading or reproducing an image by scanning a sheet-like recording medium in a main scanning direction with a laser beam applied thereto.

2. Description of the Related Art

There is known a system for recording radiation image information of a subject such as a human body with a stimulable phosphor, and reproducing the recorded radiation image information on a photosensitive medium such as a photographic film, or displaying the recorded radiation image information on a display unit such as a CRT or the like.

The stimulable phosphor is a phosphor which, when exposed to an applied radiation (X-rays, α-rays, γ-rays, electron beams, ultraviolet radiation, or the like), stores a part of the energy of the radiation, and, when subsequently exposed to applied stimulating rays such as visible light, emits light in proportion to the stored energy of the radiation. Usually, a sheet provided with a layer of the stimulable phosphor is used as a stimulable phosphor sheet (sheet-like recording medium) for easier handling.

The above known system includes an image information reading apparatus which comprises a loading unit (loading device) for accommodating a cassette (container) which stores therein a stimulable phosphor sheet with recorded radiation image information, a reading unit for reading the recorded radiation image information carried on the stimulable phosphor sheet that is removed from the cassette, and an erasing unit for erasing residual radiation image information remaining on the stimulable phosphor sheet after the recorded radiation image information has been read from the stimulable phosphor sheet.

The system also includes an image information reproducing apparatus for recording radiation image information read from a stimulable phosphor sheet on a photographic film (sheet-like recording medium). The image information reproducing apparatus has a loading unit (loading device) for accommodating a container such as a cassette or magazine with a photographic film stored therein, and a recording unit for recording the radiation image information on the photographic film.

The image information reading and reproducing apparatus have various functions to feed the sheet-like recording medium, read information from the sheet-like recording medium, and erase residual information from the sheet-like recording medium, and include various devices incorporated therein for performing those functions.

The apparatus pose no problem insofar as the above devices are functioning properly. However, when those devices fail to function properly due to aging or elapse of their service life, they tend to cause errors. If an apparatus has a simple device arrangement, then it is easy to identify device faults in such an apparatus. However, the above apparatus with various functions and various devices make it difficult for the operator to identify causes of errors.

It has been customary for the apparatus to display individual errors that have occurred to let the operator know the errors. If a plurality of errors are simultaneously caused in relation to a device that has failed, then the operator is unable to distinguish an original main error and an additional error or errors that accompany the main error from each other. It takes the operator a long period of time to identify the original main error, and it is difficult for the operator to appropriately control operation of the apparatus, i.e., to decide whether the apparatus is to be shut off or to operate continuously, when such errors occur.

### SUMMARY OF THE INVENTION

It is therefore an object of the present invention to provide a display apparatus, a display method, and an image processing system which are capable of quickly identifying the cause of an original main error even when a plurality of related errors are caused.

Another object of the present invention is to provide an image processing system which is able to perform an appropriate process after the occurrence of errors depending on the errors.

In the following description, the term “unit” shall be used in its broadest form, and should be interpreted as including any suitable software and hardware (e.g., program).

According to the present invention, a display apparatus has a first process unit for detecting errors of a plurality of devices based on detected signals from a plurality of sensors associated with the devices, respectively, and a second process unit for outputting an error message based on a combination of at least one detected error.

Almost all combinations of a plurality of errors represent combinations of an original main error and an error or errors that accompany the original main error. Error messages based on original main errors for respective combinations of a plurality of errors are prepared in advance, so that one of the error messages based on a combination of at least one error detected by the first process unit can be outputted from the second process unit. Therefore, the operator of the display apparatus can quickly identify the cause of the original main error.

The second process unit may have a third process unit for retrieving a present error pattern based on the combination of at least one detected error from an information table storing a plurality of preset error patterns and a plurality of error messages corresponding respectively to the error patterns, and a fourth process unit for reading and outputting one of the error messages which corresponds to the present error pattern if the present error pattern is present in the information table.

Since the information table is employed, a new combination of errors and an error message can easily be edited and modified to display an error that is readily recognizable by the operator.

The fourth process unit may display the error message and the at least one error of the present error pattern. The operator is thus allowed to easily recognize an error or errors relating to an original main error. Therefore, the operator is able to quickly perform a process subsequent to the occurrence of the errors.

The fourth process unit may output a message indicating that the present error pattern is not present among the preset error patterns if the present error pattern is not present in the information table.

Consequently, the operator can recognize a new combination of errors different from the preset combinations of errors, and hence can easily recognize the occurrence of an error peculiar to a site where the display apparatus is installed. If an original main error relating to such a new combination of errors is found and an appropriate error message representing the original main error is registered in the information table, then the display apparatus is capable of letting the operator know the error peculiar to the site with the appropriate error message.

The fourth process unit may have a fifth process unit for displaying a plurality of errors as error codes among the errors of the present error pattern if the present error pattern is not present in the information table. Therefore, the errors are individually displayed in addition to the error message based on the present errors, making it possible for the operator to recognize an original main error and an error or errors relating to the original main error.

The fifth process unit may display the error codes in the order of preset priority levels associated respectively therewith. If an error to be indicated early is associated with a higher priority level, then an error code corresponding to the error is displayed early, allowing the operator to quickly perform a process for the error.

According to the present invention, there is also provided a display method comprising the steps of detecting errors of a plurality of devices based on detected signals from a plurality of sensors associated with the devices, respectively, and outputting an error message based on a combination of at least one detected error. With this display method, even when a plurality of errors are caused, the cause of an original main error can quickly be identified.

According to the present invention, there is further provided an image processing system comprising an image reading apparatus for reading an image from a sheet-like recording medium by applying a laser beam to the sheet-like recording medium in a main scanning direction, and an image reproducing apparatus for reproducing an image read by the image reading apparatus, the image reproducing apparatus comprising a first process unit for detecting errors of a plurality of devices based on detected signals from a plurality of sensors associated with the devices, respectively, and a second process unit for outputting an error message based on a combination of at least one detected error.

The image reading apparatus has various functions including functions to feed the sheet-like recording medium and read information from the sheet-like recording medium, and includes various devices incorporated therein for performing those functions. If a plurality of errors occur in the image reading apparatus, it is difficult for the operator to identify the cause of an original main error.

In the image processing system, error messages based on original main errors for respective combinations of a plurality of errors are prepared in advance, so that one of the error messages based on a combination of at least one error detected by the first process unit can be outputted from the second process unit. Therefore, the operator of the image processing system can quickly identify the cause of the original main error.

The second process unit may have a retriever for retrieving a present error pattern based on the combination of at least one detected error from an information table storing a plurality of preset error patterns and a plurality of error messages corresponding respectively to the error patterns, and a message output unit for reading and outputting one of the error messages which corresponds to the present error pattern if the present error pattern is present in the information table.

Since the information table is employed, a new combination of errors and an error message can easily be edited and modified to display an error that is readily recognizable by the operator.

The information table may store information relating to processing details corresponding to the error patterns, in addition to the preset error patterns and the error messages, and the image processing system may further comprise a controller for reading information relating to processing details corresponding to the present error pattern from the information table and performing processes depending on the processing details on the devices if the present error pattern is present in the information table.

Consequently, a process such as an operation shutdown or an operation continuation subsequent to the occurrence of an error can appropriately and automatically be carried out depending on the error. This makes the operator feel easy in handling the image processing system when the operator uses the image processing system for the first time or the operator is not highly skilled. Therefore, the image processing system is given an opportunity to find wide use in the art.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram of an image processing system according to the present invention;

FIG. 2 is a vertical cross-sectional view of an image reading apparatus according to the present invention;

FIG. 3 is a schematic perspective view of a reading unit in the image reading apparatus according to the present invention;

FIG. 4 is a functional block diagram of an error process unit incorporated in an image reproducer according to the present invention;

FIG. 5 is a diagram showing details of an information table;

FIG. 6 is a diagram showing details of an error flag;

FIGS. 7 and 8 are a flowchart of a processing sequence of the error process unit;

FIG. 9 is a view showing an example of a displayed error message;

FIG. 10 is a diagram showing details of an individual error information table;

FIG. 11 is a flowchart of a processing sequence of an individual error display process unit; and

FIG. 12 is a view showing an example of a displayed new error message.

### DESCRIPTION OF THE PREFERRED EMBODIMENT

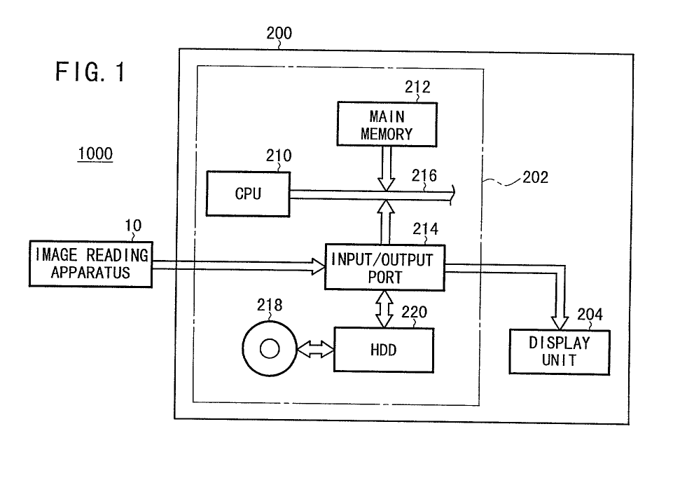

A display apparatus, a display method, and an image processing system according to the present invention are incorporated in an image processing system having an image reading apparatus and an image reproducing apparatus which use a stimulable phosphor sheet, for example, and will be described below with reference to FIGS. 1 through 12.

As shown in FIG. 1, an image processing system 1000 has an image reading apparatus 10 for reading an image and an image reproducing apparatus 200 for reproducing an image which has been read by the image reading apparatus 10.

The image reproducing apparatus 200 has an image reproducer 202 comprising a personal computer and a display 204 comprising a liquid crystal display unit, a CRT, or the like. The image reproducer 202 has a CPU 210 for executing various programs, a main memory 212 for storing various programs and data, and an input/output port 214 for exchanging data with an external device. The CPU 210, the main memory 212, and the input/output port 214 are connected to each other by a system bus 216. To the input/output port 214, there are connected the image reading apparatus 10, the display 204, and a hard disk drive (HDD) 220 for accessing a hard disk 218.

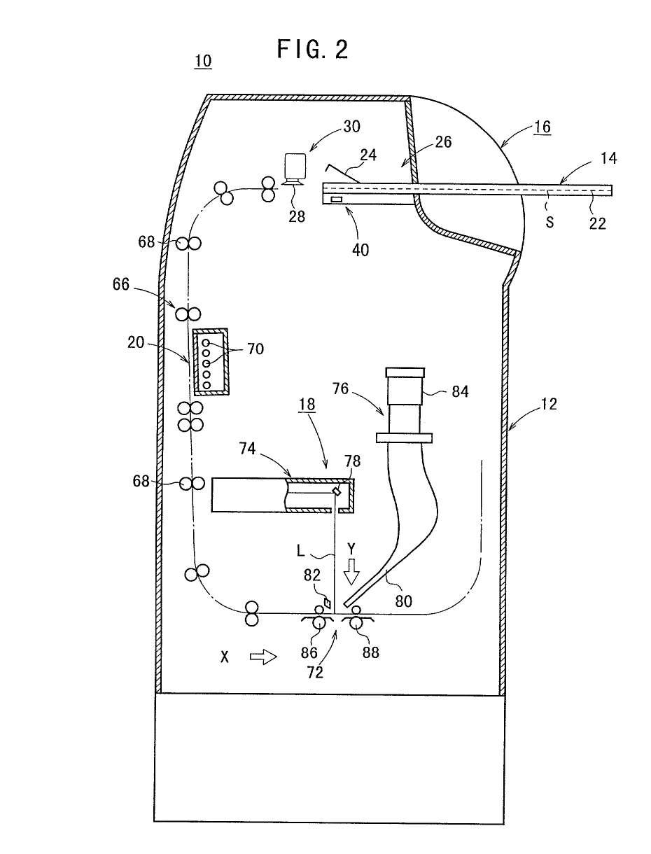

As shown in FIG. 2, the image reading apparatus 10 is arranged to scan a stimulable phosphor sheet S in a main scanning direction with a laser beam L applied thereto, collect light emitted from the stimulable phosphor sheet S upon exposure to the laser beam L, and photoelectrically read radiation image information carried on the stimulable phosphor sheet S based on the light emitted therefrom.

Specifically, the image reading apparatus 10 has a cassette loading device 16 disposed in an apparatus housing 12 for accommodating therein a cassette 14 which stores therein a stimulable phosphor sheet S as a sheet-like recording medium with recorded radiation image information of a subject, a reading unit 18 disposed in the apparatus housing 12 for photoelectrically reading the recorded radiation image information by applying a laser beam L as stimulating light to the stimulable phosphor sheet S with the recorded radiation image information, and an erasing unit 20 disposed in the apparatus housing 12 for erasing residual radiation image information remaining on the stimulable phosphor sheet S after the recorded radiation image information has been read from the stimulable phosphor sheet S.

The cassette 14 comprises a casing 22 for housing the stimulable phosphor sheet S therein, and a lid 24 openably and closably mounted on an end of the casing 22 for allowing the stimulable phosphor sheet S to be removed from and inserted into the casing 22.

The cassette loading device 16 has a loading region 26 in which the cassette 14 is inserted horizontally, a lid opening/closing mechanism (not shown) for opening and closing the lid 24, and a sheet delivery mechanism 30 having suction cups 28 for attracting and removing the stimulable phosphor sheet S from the cassette 14 and also returning the stimulable phosphor sheet S back into the cassette 14 after recorded image information has been read and remaining image information has been erased.

The erasing unit 20 and the reading unit 18 are positioned below the sheet delivery mechanism 30 and connected thereto by a reciprocating feed system 66. The reciprocating feed system 66 comprises a plurality of roller pairs 68 that make up a vertical feed path extending from the loading region 26 and a horizontal feed path extending from the lower end of the vertical feed path. The erasing unit 20 is disposed on the vertical feed path. The reading unit 18 is disposed on the horizontal feed path of the feed system 66. The erasing unit 20 has a vertical array of erasing light sources 70 that extend horizontally. The erasing unit 20 may alternatively have a single erasing light source 70 or a plurality of vertical erasing light sources 70.

The reading unit 18 comprises an auxiliary scanning feed mechanism 72 for feeding the stimulable phosphor sheet S in a horizontal auxiliary scanning direction indicated by the arrow X, a laser beam applying unit 74 for applying a laser beam L as scanning light substantially vertically downwardly indicated by the arrow Y to the stimulable phosphor sheet S which is being fed in the auxiliary scanning direction to scan the stimulable phosphor sheet S in a main scanning direction perpendicular to the auxiliary scanning direction, and an image reading unit 76 for guiding light emitted from the stimulable phosphor sheet S upon exposure to the laser beam L and photoelectrically reading the radiation image information carried on the stimulable phosphor sheet S based on the emitted light.

The laser beam applying unit 74 has an optical system 78 for bending the laser beam L which has been emitted horizontally in a substantially vertically downward direction to apply the laser beam L to the stimulable phosphor sheet S. The reading unit 18 also includes a light guide 80 and a reflecting mirror 82 that are positioned near the area where the laser beam L is applied to the stimulable phosphor sheet S. The light guide 80 serves to collect and guide the light that is emitted from the stimulable phosphor sheet S upon exposure to the laser beam L. The image reading unit 76 also has a photomultiplier 84 mounted on the upper end of the light guide 80. The auxiliary scanning feed mechanism 72 has first and second roller pairs 86, 88 positioned beneath the light guide 80 and the reflecting mirror 82 and spaced horizontally in the direction indicated by the arrow X from each other by a certain distance.

Operation of the image reading apparatus 10 thus constructed will be described below. The cassette 14 is horizontally loaded into the cassette loading region 26 that is positioned in an upper portion of the apparatus housing 12. The cassette 14 stores therein the stimulable phosphor sheet S with the radiation image information of a subject such as a human body being recorded thereon. The lid 16 of the loaded cassette 14 is opened by the lid opening/closing mechanism (not shown) in the cassette loading device 16.

Then, the sheet delivery mechanism 30 is actuated to move the suction cups 28 into the cassette 14, and the suction cups 28 attract an upper surface of the stimulable phosphor sheet S in the cassette 14. The suction cups 28 which have attracted the stimulable phosphor sheet S are moved from within the cassette 14 toward the reciprocating feed system 66, thus removing the stimulable phosphor sheet S from the cassette 14. Substantially at the same time that the leading end of the stimulable phosphor sheet S removed from the cassette 14 is gripped by the first roller pair 68, the suction cups 28 release the stimulable phosphor sheet S.

The roller pairs 68 are rotated to feed the stimulable phosphor sheet S horizontally and then vertically downwardly along the vertical feed path of the reciprocating feed system 66. After the stimulable phosphor sheet S has passed through the erasing unit 20, the stimulable phosphor sheet S is fed along the horizontal feed path to the auxiliary scanning mechanism 72 of the reading unit 18.

In the auxiliary scanning mechanism 72, the stimulable phosphor sheet S is gripped by the first and second roller pairs 86, 88 and fed horizontally in the auxiliary scanning direction indicated by the arrow X. At the same time, the laser beam L is emitted from the laser beam applying unit 74. The laser beam L first travels horizontally and then is directed downwardly indicated by the arrow Y by the optical system 78. The laser beam L is applied to the upper recording surface of the stimulable phosphor sheet S to scan the stimulable phosphor sheet S in the main scanning direction. In response to the application of the laser beam L, the upper recording surface of the stimulable phosphor sheet S emits light representing the recorded radiation image information. The emitted light is applied to the light guide 80 directly or by the reflecting mirror 82, and then guided by the light guide 80 to the photomultiplier 84, which photoelectrically reads the radiation image information based on the light.

After the radiation image information has been read from the stimulable phosphor sheet S, the auxiliary scanning feed mechanism 72 is reversed to feed the stimulable phosphor sheet S upwardly along the reciprocating feed system 66 into the erasing unit 20. In the erasing unit 20, the erasing light sources 70 are energized to remove residual radiation image information from the stimulable phosphor sheet S. Thereafter, the stimulable phosphor sheet S is returned into the cassette 14, and the lid 24 is closed. The cassette 14 is unloaded from the loading region 26, and then the stimulable phosphor sheet S is processed to record next radiation image information.

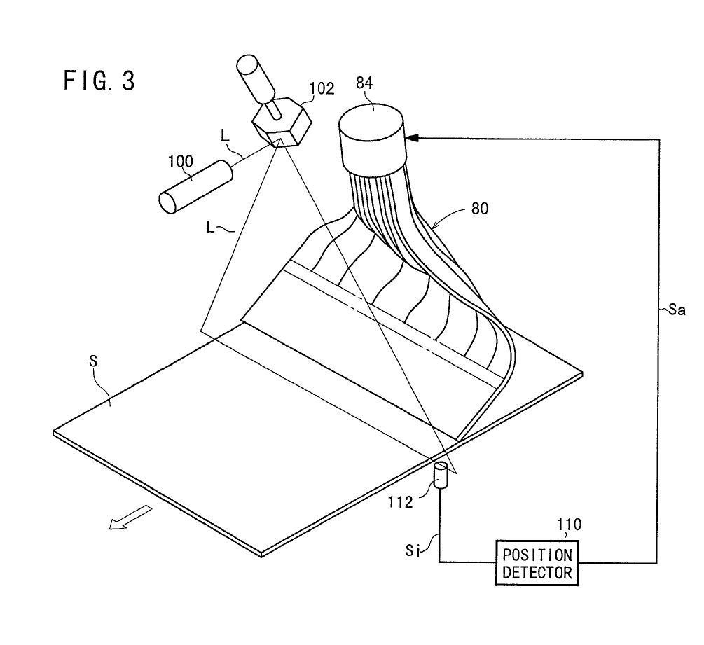

The image reading process in the reading unit 18 will specifically be described below with reference to FIG. 3. The laser beam L emitted as stimulating light from a laser beam source 100 is applied to a polygon mirror 102, i.e., a rotor having six mirror facets, which reflects the laser beam L to the stimulable phosphor sheet S. The polygon mirror 102 is rotated to scan the stimulable phosphor sheet S with the laser beam L in the main scanning direction. The recording surface of the stimulable phosphor sheet S emits light from a line along which the stimulable phosphor sheet S is scanned with the laser beam L. The emitted light is applied to the photomultiplier 84, which photoelectrically reads an image of the scanned line on the stimulable phosphor sheet S.

As the stimulable phosphor sheet S is fed in the auxiliary scanning direction, the laser beam L scans the stimulable phosphor sheet S along successive lines thereon. In this manner, the photomultiplier 84 reads one frame of image carried on the stimulable phosphor sheet S.

The photomultiplier 84 starts reading each line of image in response to a start-of-scan signal Sa from a position detector 110. The position detector 110 generates the start-of-scan signal Sa which has a given pulse duration based on a detected signal Si from a sensor 112 which detects the laser beam L applied at a transverse end of the stimulable phosphor sheet S.

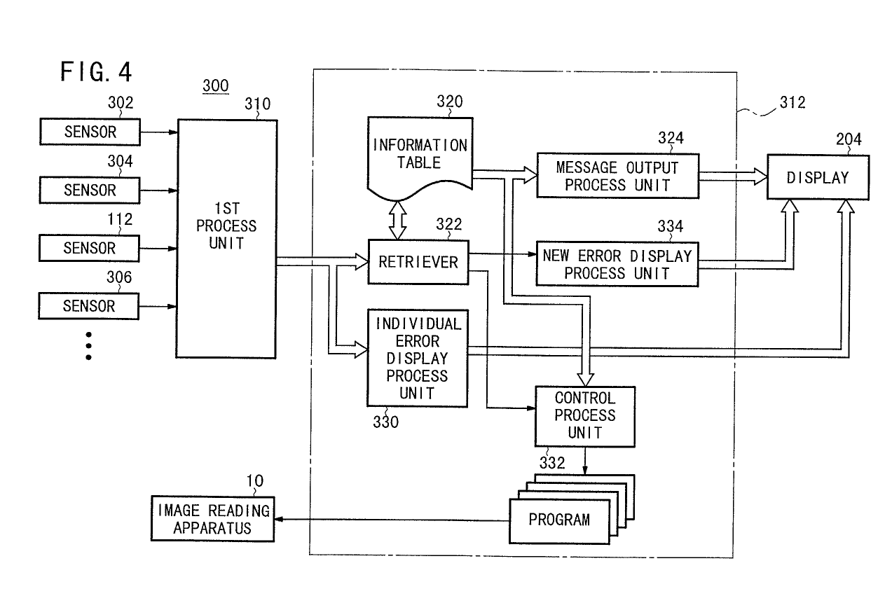

As shown in FIG. 4, the image reproducer 202 of the image processing system 1000 has an error process unit 300 for detecting errors of the various devices based on detected signals from various sensors and outputting error messages depending on combinations of the detected errors.

The error process unit 300 is software-implemented and recorded on the hard disk 218 of the image reproducer 202 shown in FIG. 1. The error process unit 300 is read from the hard disk 218 via the HDD 220 and the input/output port 214 into the main memory 212, and executed by the CPU 210 to perform desired functions.

The sensors include a first sensor 302 for detecting an intensity of the laser beam L, a second sensor 304 for detecting a rotating state of the polygon mirror 102, the sensor 112 for detecting the signal Si, a fourth sensor 306 for detecting an output level of a high-voltage power supply, and other sensors.

The error process unit 300 has a first process unit 310 for detecting errors of various devices based on detected signals from the sensors, and a second process unit 312 for outputting error messages depending on combinations of the detected errors.

The second process unit 312 has a retriever 322 for retrieving a present error pattern based on a combination of the detected errors from an information table 320, and a message output process unit 324 for reading an error message corresponding to the present error pattern and outputting the error message to the display 204 if the present error pattern is present in the information table 320.

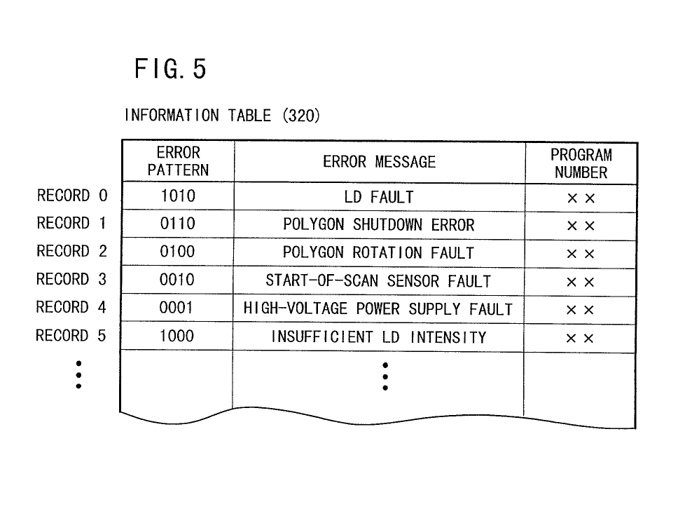

As shown in FIG. 5, the information table 320 contains a plurality of preset error patterns, a plurality of error messages corresponding to the respective error patterns, and information (program numbers) relating to processing details corresponding to the respective error patterns.

As shown in FIG. 4, the error process unit 300 also has an individual error display process unit 330 for individually displaying produced errors as error codes, a control process unit 332 for reading information (program number) relating to the processing details corresponding to the present error pattern if the present error pattern is present in the information table 320, and a new error display process unit 334 for displaying a message indicative of a new error pattern if the present error pattern is not present in the information table 320.

The information relating to the processing details refers to information representing a subsequent process such as an operation shutdown or an operation continuation upon the occurrence of the corresponding error pattern. Specifically, the information relating to the processing details refers to the number of a program for carrying out such a subsequent process.

Programs for carrying out subsequent processes include a shutdown program for outputting control signals to shut off the various devices at various timings, and a continuation program for outputting control signals to operate the various devices with a warning at various timings in order to continuously operate the image reading apparatus 10 with such a warning. The control process unit 332 activates a program corresponding to the program number which is read.

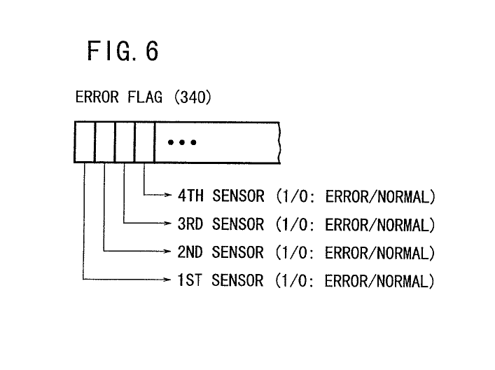

The error process unit 300 uses an error flag 340 shown in FIG. 6 in addition to the information table 320. The error flag 340 has as many bits as the number of the sensors 302, 304, 112, 306. If the information from one of the sensors contains an error, then the bit of the error flag 340 which corresponds to that sensor is set to “1”.

The 0th bit of the error flag 340 may be representative of whether an error is present or not based on the detected signal from the first sensor 302 which detects an intensity of the laser beam L. The 1st bit of the error flag 340 may be representative of whether an error is present or not based on the detected signal from the second sensor 304 which detects a rotating state of the polygon mirror 102. The 2nd bit of the error flag 340 may be representative of whether an error is present or not based on the detected signal from the third sensor 112 which detects the start-of-scan position of the laser beam L. The 3rd bit of the error flag 340 may be representative of whether an error is present or not based on the detected signal from the fourth sensor 306 which detects an output level of the high-voltage power supply.

If the detected signals from the first sensor 302 and the third sensor 112 indicate errors, then the error flag 340 is set to “1010”, which is recognized as a present error pattern.

Specific details of the error patterns, the error messages, and the processing details will be described below. However, the illustrated specific details are given by way of example only, and may be modified in various ways.

As shown in FIG. 5, an error pattern “1010” in the 0th record of the information table 320 indicates that the intensity of the laser beam L and the detection of the start-of-scan position of the laser beam L are faulty. Since these faults are caused because the laser beam source 100, which comprises a laser diode (LD), fails, the corresponding error message represents “LD FAULT”, for example. Since the start-of-scan position of the laser beam L is not detected, the image reading process cannot be performed, and hence an operation shutdown is processed. Accordingly, a program to be activated is the shutdown program.

An error pattern “0110” in the 1st record of the information table 320 indicates that the rotation of the polygon mirror 102 and the detection of the start-of-scan position of the laser beam L are faulty. Since these faults are caused because the polygon mirror 102 fails and is stopped, the corresponding error message represents “POLYGON SHUTDOWN ERROR”, for example. Since the start-of-scan position of the laser beam L is not detected, the image reading process cannot be performed, and hence an operation shutdown is processed.

An error pattern “0100” in the 2nd record of the information table 320 indicates that the rotation of the polygon mirror 102 is faulty and the start-of-scan position of the laser beam L is detected. Since the fault indicates that the polygon mirror 102 fails or rotates unstably, the corresponding error message represents “POLYGON ROTATION FAULT”, for example. Since the polygon mirror 102 fails or rotates unstably, the image reading process continues with a warning. Accordingly, a program to be activated is the continuation program.

An error pattern “0010” in the 3rd record of the information table 320 indicates that the detection of the start-of-scan position of the laser beam L is faulty. Since the fault indicates that the third sensor 112 fails, the corresponding error message represents “START-OF-SCAN SENSOR FAULT”, for example. Since the start-of-scan position of the laser beam L is not detected, the image reading process cannot be performed, and hence an operation shutdown is processed.

An error pattern “0001” in the 4th record of the information table 320 indicates that the output level of the high-voltage power supply is faulty. Since the fault indicates that the output level of the high-voltage power supply is unstable, the corresponding error message represents “HIGH-VOLTAGE POWER SUPPLY FAULT”, for example. Since the output level of the high-voltage power supply is unstable, the image reading process continues with a warning.

An error pattern “1000” in the 5th record of the information table 320 indicates that the intensity of the laser beam L is faulty and the start-of-scan position of the laser beam L is detected. Since the fault is caused because the intensity of the laser beam L is insufficient, the corresponding error message represents “INSUFFICIENT LD INTENSITY”, for example. Since the intensity of the laser beam L is insufficient, the image reading process continues with a warning.

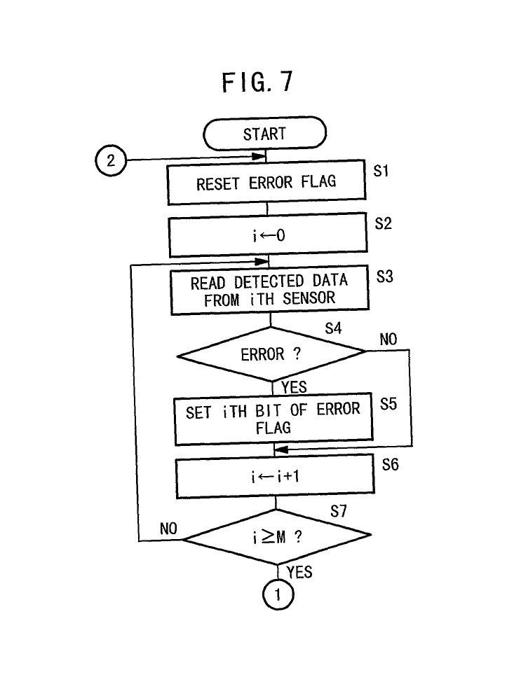

A processing sequence of the error process unit 300 will be described below with reference to FIGS. 7 through 12.

In step S1 shown in FIG. 7, the error process unit 300 initializes the error flag 340. Then, the error process unit 300 stores an initial value “0” in an index register i which is used to retrieve sensor data, thus initializing the index register i.

Then, the first process unit 310 reads detected data from an ith sensor in step S3. The first process unit 310 determines whether the read data represents an error or not in step S4.

If the read data represents an error, then control proceeds to step S5 in which the first process unit 310 sets “1” in the ith bit of the error flat 340. Thereafter, the first process unit 310 increments the value of the index register i by “+1” in step S6.

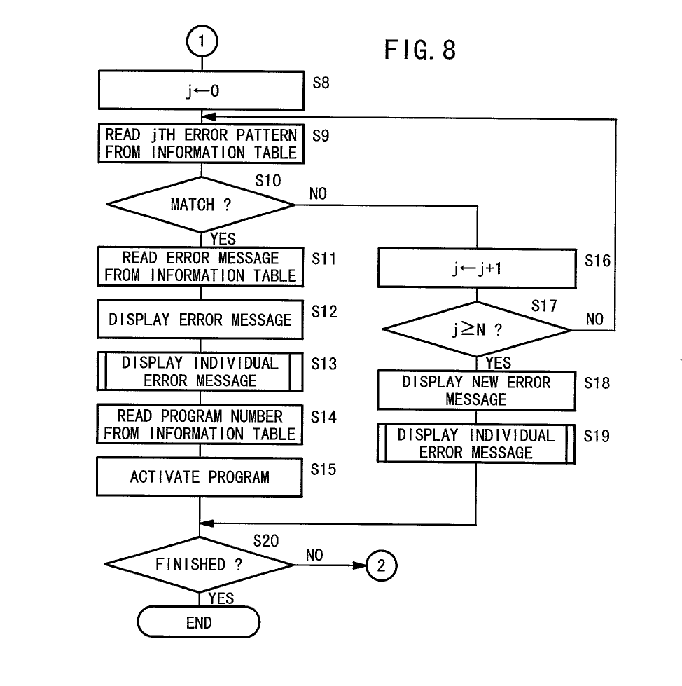

In step S7, the first process unit 310 determines whether the detected data from all the sensors have been read or not based on whether or not the value of the index sensor i is equal to or greater than the number M of the sensors. If the detected data from all the sensors have not been read, then the processing from step S3 is repeated. When the detected data from all the sensors have been read, control goes from step S7 to step S8 shown in FIG. 8. At this time, the combination of the bits of the error flag 340 provides a present error pattern. For example, if the detected data from the first sensor 302 which detects an intensity of the laser beam L and the detected data from the third sensor 112 which detects the start-of-scan position of the laser beam L represent errors, then the present error pattern is “1010”, for example.

In step S8, the first process unit 310 stores an initial value “0” in an index register j which is used to retrieve error patterns, thus initializing the index register j.

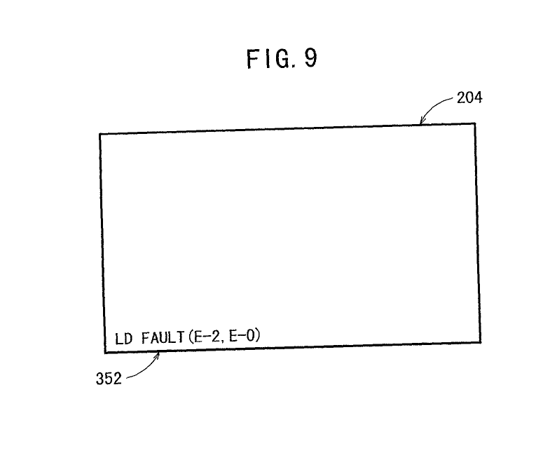

In step S9, the retriever 322 of the second process unit 312 reads an error pattern from a jth record of the information table 320. Then, the second process unit 312 determines whether the read error pattern matches the present error pattern or not in step S10. If the read error pattern matches the present error pattern, then control goes to step S11 in which the message output process unit 324 reads an error message from the jth record of the information table 320. In step S11, the message output process unit 324 displays the error message on the screen of the display 204 in step S12. For example, if the present error pattern is “1010” as described above, then since it is the same as the error pattern in the 0th record of the information table 320, the message output process unit 324 reads the error message “LD FAULT” and displays it as an error message 352 on the screen of the display 204, as shown in FIG. 9.

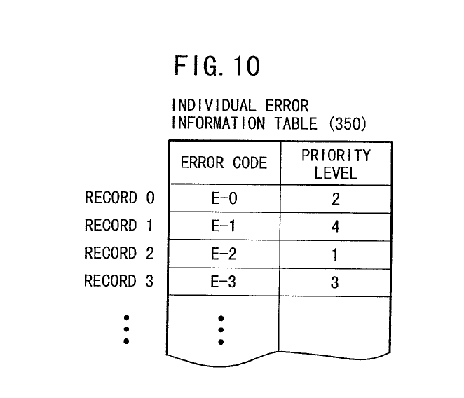

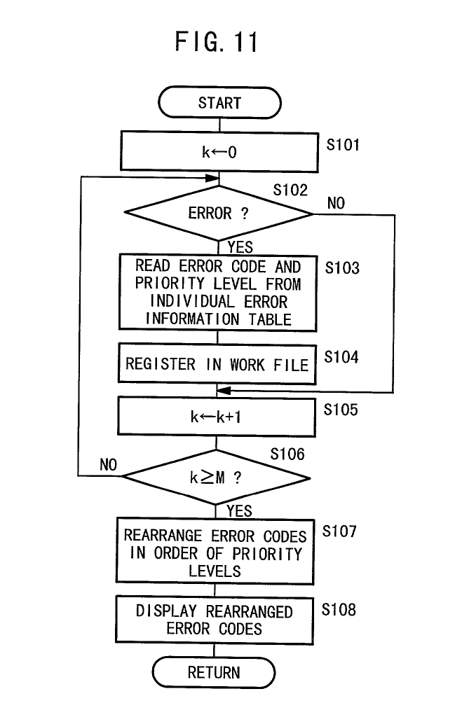

In step S13, the individual error display process unit 330 performs its own processing sequence shown in FIG. 11. The individual error display process unit 330 uses an individual error information table 350 shown in FIG. 10. As shown in FIG. 10, the individual error information table 350 stores error codes and priority levels in respective records. The records have respective record numbers which correspond to the respective bit numbers of the error flag 340. For example, an error code corresponding to the 0th bit of the error flag 340 is stored in a 0th record of the individual error information table 350, and an error code corresponding to the 2nd bit of the error flag 340 is stored in a 10th record of the individual error information table 350.

In step S101 shown in FIG. 11, the individual error display process unit 330 stores an initial value “0” in an index register k which is used to retrieve error codes, thus initializing the index register k. Then, the individual error display process unit 330 determines whether a kth bit of the error flag 340 is “1” of not, i.e., whether the detected data from a kth sensor represents an error or not, in step S102.

If the detected data represents an error, then control goes to step S103 in which the individual error display process unit 330 reads an error code and a priority level from the kth record of the individual error information table 350. In step S104, the individual error display process unit 330 registers the error code and the priority level in a work file.

Then, the individual error display process unit 330 increments the value of the index register k by “+1” in step S105. In step S106, the individual error display process unit 330 determines whether all the bits of the error flag 340 have been processed or not based on whether or not the value of the index sensor k is equal to or greater than the number M of the sensors. If the value of the index sensor k is less than the number M of the sensors, then control returns to step S102 to process a next bit of the error flag 340. When the value of the index sensor k is equal to or greater than the number M of the sensors, control goes from step S106 to step S107 in which the individual error display process unit 330 rearranges the error codes registered in the work file in the order of the priority levels.

In step S108, the individual error display process unit 330 displays the rearranged error codes in parentheses following the error message 352, as shown in FIG. 9. At this time, the error codes are displayed in the order of the priority levels. In the above example, since the present pattern is “1010”, the error codes “E-0”, “E-2” are selected. As shown in FIG. 9, the error code “E-2” is displayed to the left of the error code “E-0” because the error code “E-2” has a higher priority level than the error code “E-0”.

After step S108, the processing sequence of the individual error display process unit 330 is put to an end, and control returns to the main routine shown in FIG. 8.

In FIG. 8, the control process unit 332 reads a program number from the jth record of the information table 320 in step S14. The control process unit 332 activates the program corresponding to the read program number in step S15. In the above example, the control process unit 332 activates the shutdown program.

If the read error pattern does not match the present error pattern in step S10, then control goes to step S16 in which the control process unit 332 increments the value of the index register j by “+1”. Thereafter, in step S17, the control process unit 332 determines whether all the records have been retrieved or not based on whether or not the value of the index register j is equal to or greater than the number N of the records of the information table 320. If not all the records have been retrieved, then control returns to step S9 to retrieve a next record.

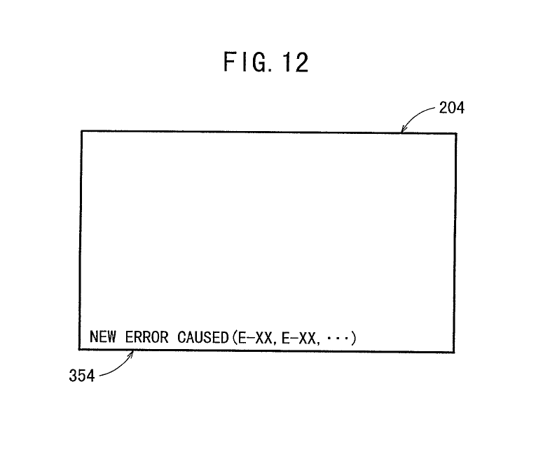

If all the records have been retrieved in step S17, then it means that the information table 320 does not contain an error pattern that matches the present error pattern, and control goes to step S18. In step S18, the new error display process unit 334 displays a new error message 354 (see FIG. 12) indicating that a new error has occurred, e.g., “NEW ERROR HAS OCCURRED”, on the screen of the display 204.

In step S19, the individual error display process unit 330 performs its processing sequence which has been described above with reference to FIG. 11. In the processing sequence, the individual error display process unit 330 displays error codes in parentheses following the new error message 354, as shown in FIG. 12.

After step S15 or step S19, control goes to step S20 which determines whether there is a program end request, such as a request to turn off the power supply or a request to perform a maintenance process, for the error process unit 300.

If there is no program end request, then control returns to step S1 shown in FIG. 7 to repeat the processing from step S1. If there is a program end request, then the processing sequence of the error process unit 300 is put to an end.

As described above, the image processing system 1000 has the first process unit 310 for detecting errors of various devices based on detected signals from the sensors, and the second process unit 312 for outputting error messages depending on combinations of at least one detected error.

Almost all combinations of a plurality of errors represent combinations of an original main error and an error or errors that accompany the original main error. Error messages based on original main errors for respective combinations of a plurality of errors are prepared in advance, so that one of the error messages based on a combination of at least one error detected by the first process unit 310 can be outputted from the second process unit 312. Therefore, the operator of the image processing system 1000 can quickly identify the cause of the original main error.

In the illustrated embodiment, the second process unit 312 has the retriever 322 for retrieving a present pattern based on a combination of at least one detected error from a group of error patterns stored in the information table 320, and the message output process unit 324 for reading and outputting an error message corresponding to the present error pattern if the present error pattern is present in the information table 320.

Since the information table 320 is employed, a new combination of errors and an error message can easily be edited and modified to display an error that is readily recognizable by the operator.

The information table 320 stores, in addition to a plurality of preset error patterns and a plurality of error messages corresponding to the error messages, information (program numbers) relating to processing details corresponding to the respective error patterns. The error process unit 300 has the control process unit 332 for ; activating programs corresponding to the program numbers. Consequently, a process such as an operation shutdown or an operation continuation subsequent to the occurrence of an error can appropriately and automatically be carried out depending on the error. This makes the operator feel easy in handling the image processing system 1000 when the operator uses the image processing system 1000 for the first time or the operator is not highly skilled. Therefore, the image processing system 1000 is given an opportunity to find wide use in the art.

In the above embodiment, an error message and errors that make up a present error pattern are displayed to allow the operator to easily recognize an error or errors relating to an original main error. Therefore, the operator is able to quickly perform a process subsequent to the occurrence of the errors.

In the above embodiment, in the absence of a present error pattern in the information table 320, a new error message 354 indicative of a new error is outputted. Consequently, the operator can recognize a new combination of errors different from the preset combinations of errors, and hence can easily recognize the occurrence of an error peculiar to a site where the image processing system 1000 is installed. If an original main error relating to such a new combination of errors is found and an appropriate error message representing the original main error is registered in the information table 320, then the image processing system 1000 is capable of letting the operator know the error peculiar to the site with the appropriate error message 352.

In the above embodiment, in the absence of a present error pattern in the information table 320, plural errors of the errors of the present error pattern are displayed as error codes. Therefore, the errors are individually displayed in addition to the error message 352 based on the present errors, making it possible for the operator to recognize an original main error and an error or errors relating to the original main error.

Error codes are also displayed in the order of preset priority levels associated therewith. If an error to be indicated early is associated with a higher priority level, then an error code corresponding to the error is displayed early, allowing the operator to quickly perform a process for the error.

With the display apparatus and the display method according to the present invention, even when a plurality of related errors are caused, the cause of an original main error can quickly be identified.

With the image processing system according to the present invention, even when a plurality of related errors are caused, the cause of an original main error can quickly be identified, and a process subsequent to the occurrence of the error can appropriately be performed depending on the error.

Although a certain preferred embodiment of the present invention has been shown and described in detail, it should be understood that various changes and modifications may be made therein without departing from the scope of the appended claims.

What is claimed is:

1. A display apparatus comprising:
a first process unit for detecting errors of a plurality of devices based on detected signals from a plurality of sensors associated with said devices, respectively; and
a second process unit for outputting an error message based on a combination of at least one detected error.

2. A display apparatus according to claim 1, wherein said second process unit comprises:
a third process unit for retrieving a present error pattern based on the combination of at least one detected error from an information table storing a plurality of preset error patterns and a plurality of error messages corresponding respectively to said error patterns; and
a fourth process unit for reading and outputting one of said error messages which corresponds to the present error pattern if the present error pattern is present in said information table.

3. A display apparatus according to claim 2, wherein said fourth process unit comprises:
means for displaying said error message and said at least one error of said present error pattern.

4. A display apparatus according to claim 2, wherein said fourth process unit comprises:
means for outputting a message indicating that said present error pattern is not present among said preset error patterns if said present error pattern is not present in said information table.

5. A display apparatus according to claim 2, wherein said fourth process unit comprises:
a fifth process unit for displaying a plurality of errors as error codes among the errors of said present error pattern if said present error pattern is not present in said information table.

6. A display apparatus according to claim 5, wherein said fifth process unit comprises:
means for displaying the error codes in the order of preset priority levels associated respectively therewith.

7. A display method comprising the steps of:
(a) detecting errors of a plurality of devices based on detected signals from a plurality of sensors associated with said devices, respectively; and
(b) outputting an error message based on a combination of at least one detected error.

8. A display method according to claim 7, wherein said step (b) comprises the steps of:
(c) retrieving a present error pattern based on the combination of at least one detected error from an information table storing a plurality of preset error patterns and a plurality of error messages corresponding respectively to said error patterns; and
(d) reading and outputting one of said error messages which corresponds to the present error pattern if the present error pattern is present in said information table.

9. A display method according to claim 8, wherein said step (d) comprises the step of:
displaying said error message and said at least one error of said present error pattern.

10. A display method according to claim 8, wherein said step (d) comprises the step of:
outputting a message indicating that said present error pattern is not present among said preset error patterns if said present error pattern is not present in said information table.

11. A display method according to claim 8, wherein said step (d) comprises the step of:
(e) displaying a plurality of errors as error codes among the errors of said present error pattern if said present error pattern is not present in said information table.

12. A display method according to claim 11, wherein said step (e) comprises the step of:
displaying the error codes in the order of preset priority levels associated respectively therewith.

13. An image processing system comprising:
an image reading apparatus for reading an image from a sheet-like recording medium by applying a laser beam to the sheet-like recording medium in a main scanning direction; and
an image reproducing apparatus for reproducing an image read by said image reading apparatus;
said image reproducing apparatus comprising:
a first process unit for detecting errors of a plurality of devices based on detected signals from a plurality of sensors associated with said devices, respectively; and
a second process unit for outputting an error message based on a combination of at least one detected error.

14. An image processing system according to claim 13, wherein said second process unit comprises:
a retriever for retrieving a present error pattern based on the combination of at least one detected error from an information table storing a plurality of preset error patterns and a plurality of error messages corresponding respectively to said error patterns; and
a message output unit for reading and outputting one of said error messages which corresponds to the present error pattern if the present error pattern is present in said information table.

15. An image processing system according to claim 14, wherein said information table stores information relating to processing details corresponding to said error patterns, in addition to said preset error patterns and said error messages corresponding to said error patterns, further comprising a controller for reading information relating to processing details corresponding to the present error pattern from said information table and performing processes depending on the processing details on the devices if said present error pattern is present in said information table.
